(19) United States
(12) Patent Application Publication
(10) Pub. No.: US 2005/0210723 A1
(43) Pub. Date: Sep. 29, 2005

(54) Compact disc and photograph storage page

(76) Inventor: John P. Jordan, Rehoboth, MA (US)

Correspondence Address: Richard D. Zimmerman;Chace Ruttenberg & Freedman LLP, Suite 300, One Park Row, Providence, RI, 02903, US

(21) Appl. No.: 10/807,632

(22) Filed: Mar. 24, 2004

(51) Int. Cl. G09F 19/00

(52) U.S. Cl. 40/537; 402/79; 40/776

(57) ABSTRACT

A storage page for the display of compact discs and photographs, having a back sheet attached to a cover sheet to create one or more pockets for storage of photographs or compact discs. The cover sheet has a slit for insertion of the photograph or compact disc into the pocket. Selective joining of the back sheet and cover sheet create means to assist in holding the photograph or compact disc in place. The page preferably is substantially rectangular, and may have one edge hole-punched for inserting in a loose-leaf binder. The page also may include a memo area for the recording and display of notes, descriptions and other indicia.

### TECHNICAL FIELD

The technical field of this invention concerns storage pages, such as those used in albums and binders to store and display compact discs, photographs and negatives.

### BACKGROUND

Albums to store and display photographs, negatives and memorabilia are well known. Early versions included bound books in which photographs were glued to the pages. Later albums included mounting tabs, which could be affixed by the user at the desired location to hold the photograph or negative on the album page, and adhesive surfaces covered by a transparent plastic sheet, as well as hole-punched album pages for insertion in loose-leaf binders. Some pages include memo areas for notes and other indicia concerning the displayed material.

After digitized data began to be recorded on compact discs (hereafter “CD” or “CDs”), storage pages, albums, binders and folios were developed to store the CDs. Devices for the recording of digital images, such as hand-held digital cameras, are becoming increasingly affordable and available. As more images are recorded on CD, CDs substitute for negatives, and photographs are printed from digital data stored on CDs, there exists an increasing need for a storage page that can store and display a photograph, and store the CD on which the image is recorded.

What is needed is further improvement in storage pages to permit the display of photographs with a storage area for a compact disc. What is also needed is a page that permits the display of photographs, that stores a CD, and that includes a memo area for writing.

### SUMMARY OF THE INVENTION

The present invention concerns a new page for the storage and display of photographs and similar material, which page also includes a storage area for a CD. The storage page has a back sheet attached to a cover sheet to create one or more pockets for storage of photographs or CDs. The cover sheet has a slit for insertion of the photograph or CD into the pocket. Selective joining of the back sheet and cover sheet creates a means to assist in holding the photograph or CD in place. The page preferably is substantially rectangular, and may have one edge hole-punched for inserting in a loose-leaf binder. The page also may include a memo area for the recording and display of notes, descriptions and other indicia.

### BRIEF DESCRIPTION OF THE DRAWINGS

These and other features, aspects and advantages of the present invention will become better understood with reference to the following description, appended claims, and accompanying drawings where

FIG. 1 is a plan view of the assembled single pocket storage page;

FIG. 2 is a plan view of an assembled double pocket storage page;

FIG. 3 is a plan view of an assembled double pocket storage page, with alternative support lines;

FIG. 4 is an exploded perspective view of a storage page;

FIG. 5 is an exploded perspective view of a double sided storage page; and

FIG. 6 is a plan view of a single pocket storage page showing a memo area containing a card.

### DETAILED DESCRIPTION OF THE DISCLOSURE

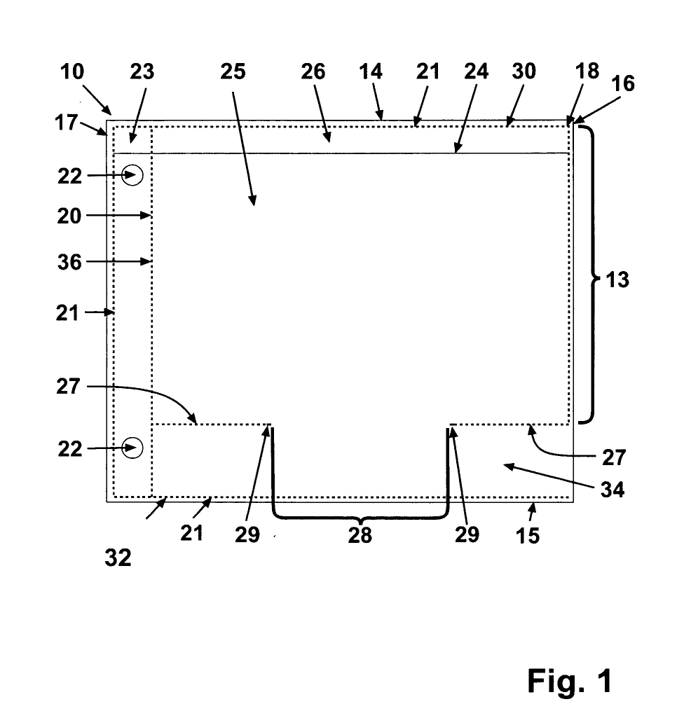

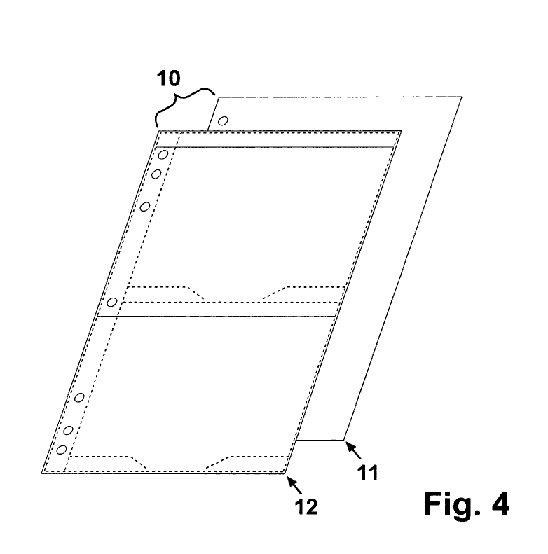

As shown in FIGS. 1 and 4, the storage page 10 is comprised of a back sheet 11 and a cover sheet 12, and preferably is substantially rectangular, having two substantially parallel long edges 14, 15 and two substantially parallel short edges 16 and 17. The storage page could be of any size or shape, but rectangular shape is preferable to fit albums, bindings and folios, and the storage page is preferably sized to fit common album, binding and folio sizes. The cover sheet is a sheet of flexible transparent plastic, preferably polypropylene or polyester.

As shown in FIG. 4, the back sheet 11 is sized to fit the cover sheet, and ordinarily is substantially rectangular. The back sheet 11 is made of a material that will not scratch or damage the CD surface on which the data is recorded. The material preferably is of a non-woven polyester microfiber construction, though a variety of materials could work.

The cover sheet 12 and the back sheet 11 are attached to create a pocket 13. The attachment means may include attachment lines 18 created by heat or sonic welding, or hot melt glue, but when a compatible plastic cover sheet and non-woven microfiber back sheet are used, the attachment means is preferably heat or sonic welding, which has cost and efficiency benefits. Attachment lines can be in a continuous attachment line 19, or points of attachment 20 in line.

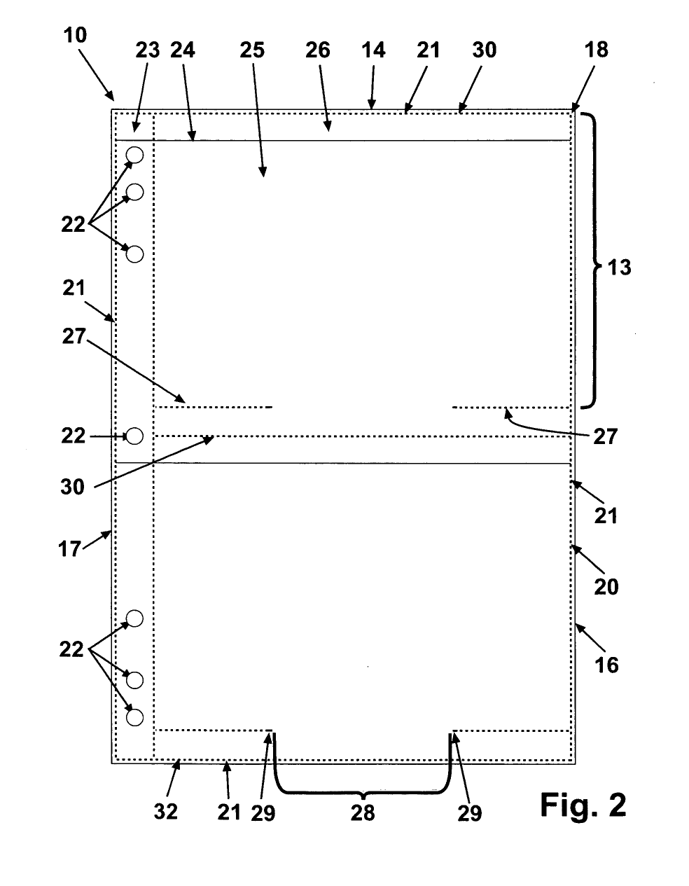

The back sheet and cover sheet may be attached around the perimeter in perimeter attachment lines 21, as shown in FIGS. 1, 2 & 3. Binding holes 22 may be formed in a binding strip 23 near an edge of the storage page to permit easy insertion in a loose-leaf binder or folio. A binding attachment line 36 near the binding holes 22, or if there are no binding holes, the perimeter attachment line 21, or an attachment line near a perimeter attachment line, serves as a boundary of a pocket 13, and if present, strengthens the binding strip 23 to resist tearing or stretching of material near the binding holes.

Pockets are sized to hold standard size photographs, typically 4×6 inch and 4×7 inch, and CDs. By appropriate selection of sizes, a pocket will be suitable to hold either a photograph or a CD, allowing the user greater flexibility. The pockets are accessed for insertion of a photograph or CD through a slit line 24, which is a cut or separation in the cover sheet 12. The slit line preferably is formed before the cover sheet is attached to the back sheet. The slit line divides the cover sheet covering a pocket into a large cover portion 25 and a small cover portion 26. To insert a CD or photograph, the large cover portion 25 is pulled away from the back sheet 11, and the CD or photograph is inserted through the slit line 24 and between the large cover portion and the back sheet 11. When the CD or photograph is fully inserted, the small cover portion is lifted over the CD or photograph to completely enclose it between the cover sheet and the back sheet.

The rectangular small cover portion is attached to the back sheet by attachment lines on three sides, the top, and two opposing narrow sides, as shown in FIGS. 1, 2 & 3, and does not fold up like a flap, as in many known CD storage pages. Rather, the attachment lines on the narrow sides create tension resisting the folding up of the small cover portion. The small cover portion flexes because of the flexibility of the cover sheet material. When the small cover portion is flexed over the CD, it holds the CD in the pocket to prevent the CD from inadvertently falling out. The CD is removed by flexing the small cover portion over the CD, and removing the CD through the slit.

The storage page 10 preferably is constructed with one, two or four pockets. As shown in FIG. 1, with a single cover sheet and a single back sheet, the storage page may have one pocket when the storage page is approximately 5.75 inches by 6.875 inches. Two pockets may be constructed with a storage page sized approximately 9.875 inches by 6.875 inches, including a binding strip, as shown in FIGS. 2 & 3. Pockets are approximately 4.5 inches by 6.16 inches when the storage is intended for photographs 4 inches by 6 inches, in size, and pockets are approximately 4.5 inches by 7.16 inches when the storage page is intended for photographs 4 inches by 7 inches in size. The small cover portion preferably will be substantially rectangular, and will measure approximately 0.40625 inches in its narrow dimension.

Pockets will have one or more support lines 27 to assist in holding the CD or photograph in place, which support lines are points or lines of attachment where the cover sheet and back sheet are attached. As shown in FIGS. 1 & 2, the support line may be a line with a gap 28 to permit the CD to project below the two portions of the line. The support line end points 29 restrict movement of a CD, and the support lines hold the photograph between the support lines 27 and the top attachment line 30.

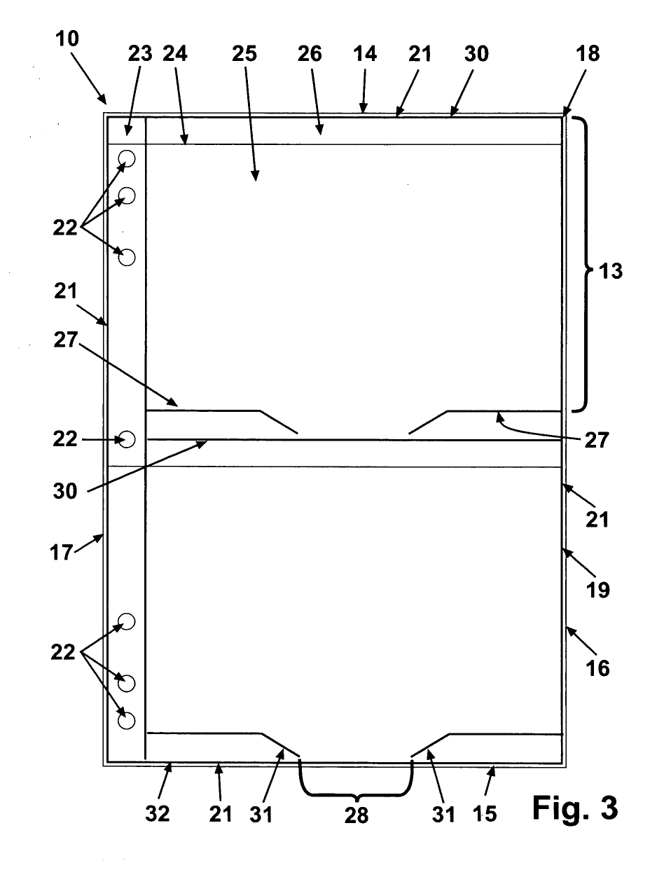

Alternative support lines are shown in FIG. 3, in which the support line 27 is in line, with a gap 28, but has an angled end portion 31, which is positioned at an angle to the line of the support line 27, and extends substantially from one of the support lines to the bottom attachment line 32 for a single or the lower pocket on a two pocket page, or to the top attachment line 30 of the lower pocket for the upper pocket on a two pocket page. Compact discs are a standardized 4.75 inches in diameter, and when inserted in the 4.5 inch pocket, a portion of the CD extends below the support line through the gap 28, so that the CD fits into the pocket, and between both large cover portion and small cover portion and the back sheet. With a standard size 4.75 inch CD, and the preferred approximately 4.5 inch pocket height, the CD will extend through the gap 28 approximately one-quarter inch below the straight support line 27 shown in FIG. 1, and approximately one-quarter inch below the straight portion of the support line 27 shown in FIG. 3, to rest on and be supported by the angled end portion 31.

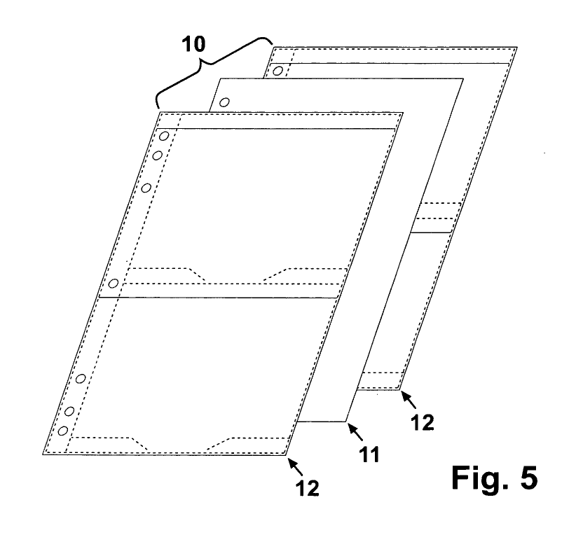

The number of pockets can be doubled by making the storage page two-sided. As shown in FIG. 5, a cover sheet 12 may be attached to both sides of the back sheet, thereby doubling the number of pockets. When the storage page is two-sided, a separate cover sheet may be attached to both sides of the back sheet, or a single cover sheet may be folded, and the back sheet inserted between the two faces of the folded cover sheet.

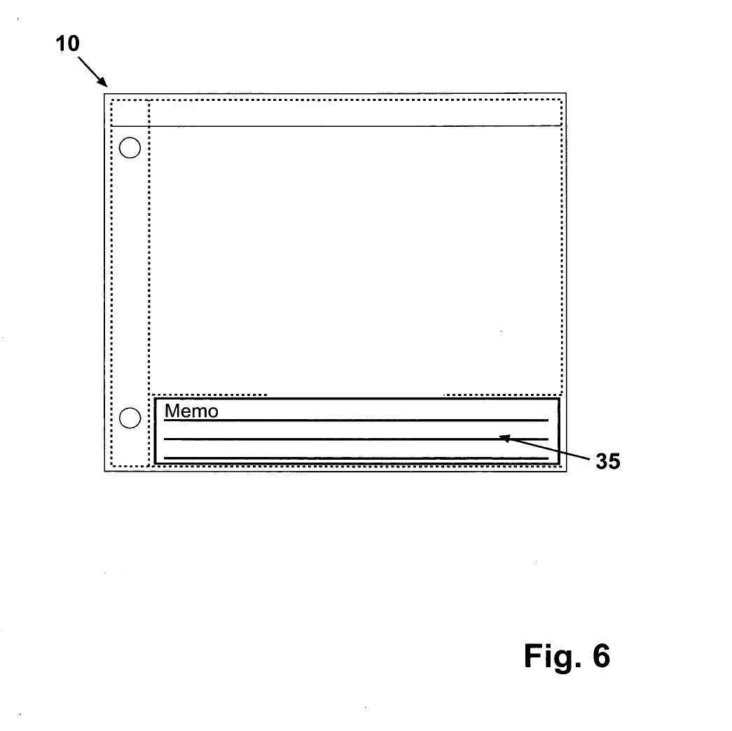

As shown in FIG. 1, a memo area 34 can be created, by allowing space around the pockets, to allow insertion of a card 35 with instruction, with lines or similar writing, as shown in FIG. 6, to permit the user to record indicia. A word or words, such as “memo”, “photo”, “date” or similar message can be assigned to and identify each pocket, to identify a caption or title for the display material in that pocket.

1. A storage page comprising: a back sheet having a first side and a second side, a transparent first cover sheet, in which both the back sheet and first cover sheet are substantially rectangular and have substantially parallel long edges, parallel short edges, and a width and a height, the first cover sheet is attached to the first side of the back sheet by an attachment means which forms attachment lines, the attachment lines forming one or more pockets between the first cover sheet and the first side of the back sheet, the pockets being sized to hold, at the user's option, either a standard size photograph or a standard size compact disc, the first cover sheet having a slit for each pocket to allow insertion of a compact disc or photograph into each pocket, where each slit divides the first cover sheet into a large cover portion and a small cover portion for each pocket, and where each pocket has a support line which has a gap, the gap sized to allow a compact disc to be positioned on either side of the support line by projecting through the gap.

2. The storage page of claim 1 in which a second cover sheet is attached to the second side of the back sheet to form one or more pockets between the second side of the back sheet and the second cover sheet, and the second cover sheet having a slit for each pocket to allow insertion of a compact disc or photograph into each pocket, and where each slit divides the second cover sheet into a large cover portion and a small cover portion for each pocket.

3. The storage page of claim 2 in which the attachment means is sonic welding.

4. The storage page of claim 2 in which the attachment means is heat welding.

5. The storage page of claim 2 in which the attachment means is hot melt glue.

6. The storage page of claim 2 having a memo area.

7. The storage page of claim 6 in which the memo area has a card for displaying indicia.

8. The storage page of claim 2 in which all pockets are sized approximately 4.5 inches by 6.16 inches.

9. The storage page of claim 2 in which all pockets are sized approximately 4.5 inches by 7.16 inches.

10. The storage page of claim 2 in which the support line has angled portions adjacent to the gap, which angled portions are at an angle to the support line.

11. The storage page of claim 1 in which one or more of the small cover portions are substantially rectangular and are smaller than one-half inch in their narrow dimension.

12. The storage page of claim 2 in which one or more of the small cover portions are substantially rectangular and are smaller than one-half inch in their narrow dimension.
